(19) United States
(12) Patent Application Publication
(10) Pub. No.: US 2026/0307287 A1
(43) Pub. Date: Oct. 8, 2026

(54) PLATE CUTTING DEVICE AND METHOD OF IMPLEMENTATION

(71) Applicant: Chin-chen Huang, Taichung City (TW)

(72) Inventor: Chin-chen Huang, Taichung City (TW)

(21) Appl. No.: 19/171,000

(22) Filed: Apr. 4, 2025

(51) Int. Cl. B26D 7/00

(52) U.S. Cl. CPC B26D 7/0006; B26D 2007/0012

(57) ABSTRACT

The present invention relates to a plate cutting device and associated method of implementation, specifically designed to process the edges of multiple plates. The plate cutting device comprises: a main body, a first cutting assembly, and a second cutting assembly. The first cutting assembly comprises a first cutting unit having a pair of first cutting zones and a first support zone. The second cutting assembly comprises a second cutting unit having a second cutting zone and a pair of second support zones. The first cutting unit is configured to process an edge of one plate to form a convex edge whilst the second cutting unit is configured to process an edge of another plate to form a complementary concave edge, allowing the convex and concave edges to interlock seamlessly. By employing this configuration, the present invention enables precise and stable plate joining, enhancing structural integrity and ease of assembly.

### FIELD OF INVENTION

The present invention relates to a plate cutting device and an associated method of implementation, specifically a device configured to process an edge of a plate into either a convex or concave edge, thereby facilitating the interlocking engagement of two plates through complementary formations.

### BACKGROUND OF THE PRESENT INVENTION

In conventional construction and renovation applications, the stability and accuracy of joints between plates heavily depend on the uniformity of the joint surfaces. However, manufacturing inconsistencies often result in slight irregularities, leading to unstable joints between adjacent plates. This instability can compromise both the structural integrity and the visual appearance of the assembly, increasing the risk of detachment or failure due to external forces over time.

Accordingly, there is a technical need for an advanced plate cutting mechanism capable of producing precisely interlocking structures. Such a mechanism would enhance joint stability and durability, addressing the limitations of conventional methods.

### SUMMARY OF THE PRESENT INVENTION

To address the aforementioned limitations, the present invention introduces a plate cutting device incorporating first and second cutting assemblies symmetrically positioned on opposite sides of a main body. These structures enable the creation of complementary convex and concave formations on the edges of plates, ensuring secure and stable interlocking engagements.

The device comprises a main body extending along a longitudinal axis, a first cutting assembly positioned on one lateral side of the main body, and a second cutting assembly symmetrically positioned on the opposite lateral side. The first cutting assembly comprises a first guide channel and a first cutting unit positioned within the first guide channel. The first cutting unit includes a pair of first cutting zones and a first support zone, with the first support zone being recessed between the pair of first cutting zones, and each first cutting zone including multiple first cutting projections that extend upward from an upper surface of the respective first cutting zone. Similarly, the second cutting assembly comprises a second guide channel and a second cutting unit positioned within the second guide channel. The second cutting unit includes a second cutting zone located between a pair of second support zones, with the second cutting zone extending above the pair of second support zones, and the second cutting zone including multiple second cutting projections that extend upward from an upper surface of the respective second cutting zone. The first guide channel is configured to align with an edge of one plate to guide the first cutting unit in processing the plate along the longitudinal axis to form a convex edge. Conversely, the second guide channel is configured to align with an edge of another plate to guide the second cutting unit in processing the plate along the longitudinal axis to form a concave edge. Consequently, the two plates can be joined by interlocking engagement of the convex edge and the concave edge.

In some embodiments, each first cutting zone includes multiple first apertures and the second cutting zone includes multiple second apertures. Each first cutting projection is arranged around the periphery of a corresponding first aperture, and each second cutting projection is arranged around the periphery of a corresponding second aperture.

In some embodiments, the first and second apertures are arranged in a staggered configuration.

In some embodiments, a spacing between the adjacent first apertures is less than or equal to a diameter of the first apertures, while a spacing between the adjacent second apertures is less than or equal to a diameter of the second apertures.

In some embodiments, the first and second apertures are formed by a punching process, and the first and second cutting projections are burrs resulting from the punching process.

In some embodiments, the main body further comprises a first assembly slot and a second assembly slot disposed on opposite lateral sides that can receive the detachable first and second cutting assemblies, respectively.

In some embodiments, the device further comprises multiple securing components. The first support zone includes multiple first fastening holes and each second support zone includes multiple second fastening holes. Each securing component extends through a first fastening hole and a second fastening hole to secure the first cutting assembly and the second cutting assembly within the first assembly slot and the second assembly slot, respectively.

In some embodiments, each first cutting zone includes a first entry point and a first guiding surface, the first guiding surface having a height that gradually decreases toward the first entry point, while each second cutting zone includes a second entry point and a second guiding surface, the second guiding surface also having a height that gradually decreases toward the second entry point.

The present invention further discloses a method of implementing the plate cutting device, comprising the steps of:
Step (A): Providing a plate cutting device described above along with at least two plates;
Steps (B): Using the first cutting unit to process an edge of a plate, forming a convex edge, and using the second cutting assembly to process an edge of another plate, forming a concave edge; and
Step (C): Engaging the convex edge of one plate with the concave edge of the other plate, creating a mechanically interlocked joint.

The following detailed description outlines the technical aspects and implementation of the invention, with reference to the accompanying drawings to facilitate a clearer understanding.

### BRIEF DESCRIPTION OF THE DRAWINGS

FIG. 1 is a schematic diagram of the plate cutting device;

FIG. 2 is an alternate perspective view of the device;

FIG. 3 is an exploded structural view of the device;

FIG. 4 is a diagram illustrating the cutting process of the first cutting assembly;

FIG. 5 is a diagram illustrating the cutting process of the second cutting assembly;

FIG. 6 is a top view of the first cutting assembly;

FIG. 7 is a top view of the second cutting assembly;

FIG. 8 is a cross-sectional view along section line 8-8 in FIG. 4;

FIG. 9 is a cross-sectional view along section line 9-9 in FIG. 5;

FIG. 10 is a schematic diagram of two plates after interlocking engagement; and

FIG. 11 is a flowchart illustrating the method of implementing the device.

### DETAILED DESCRIPTION OF THE PREFERRED EMBODIMENTS

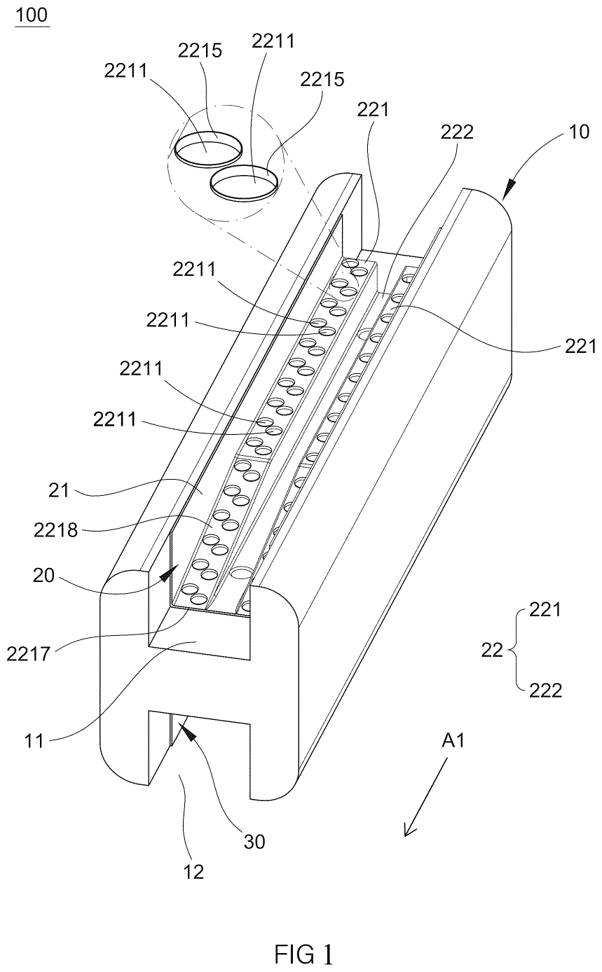

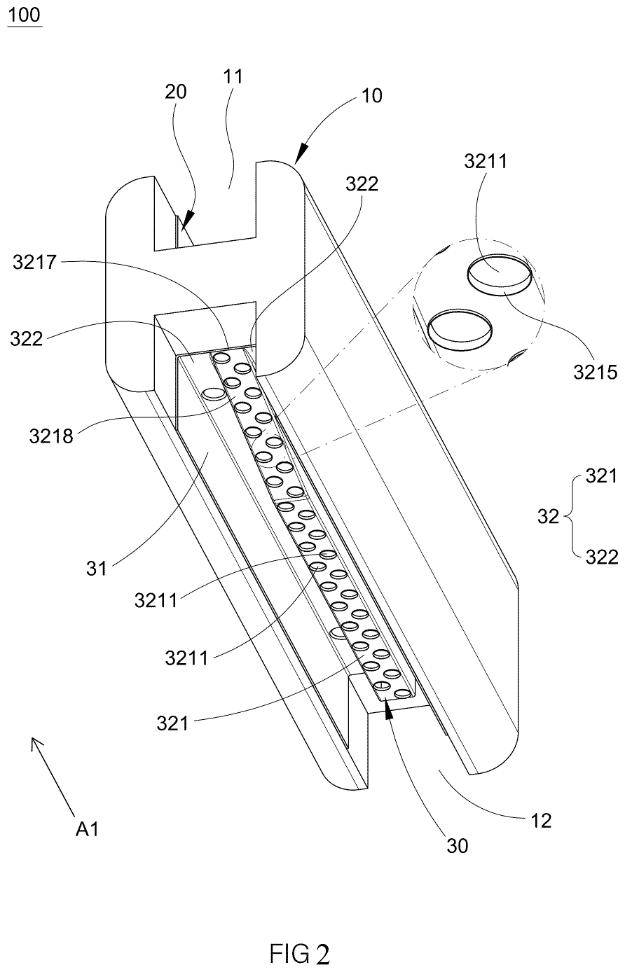

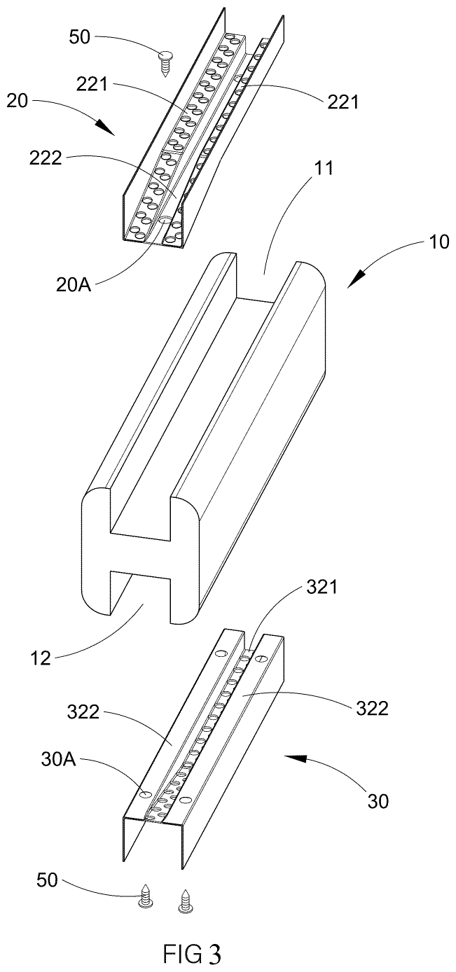

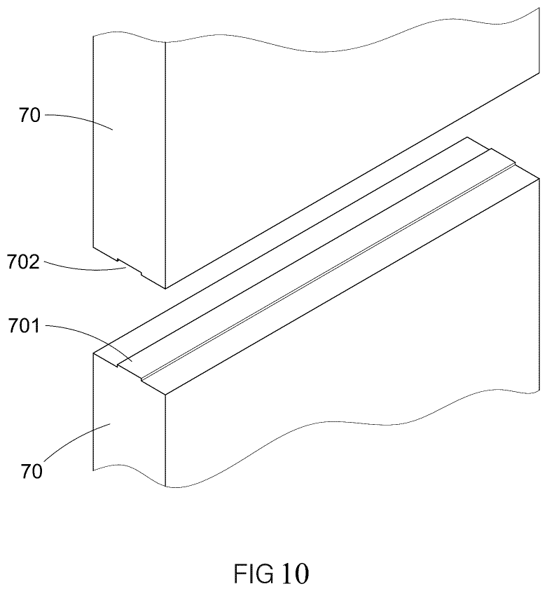

As shown in FIGS. 1 to 10, the present invention relates to a plate cutting device 100, specifically designed for processing the joint surfaces of multiple plates 70 on one edge, facilitating a smooth joint between two adjacent plates 70. These plates 70 may include, but are not limited to, gypsum boards or other panel materials intended to be joined.

The plate cutting device 100 comprises: a main body 10, a first cutting assembly 20, and a second cutting assembly 30. The main body 10, which may assume a block-like configuration for ergonomic handling, extends along a longitudinal axis A1.

The first cutting assembly 20 is located on one lateral side of the main body 10 and comprises a first guide channel 21 and a first cutting unit 22 positioned within the first guide channel 21. The first cutting unit 22 includes a pair of first cutting zones 221 and a first support zone 222, with the first support zone 222 being recessed between the pair of first cutting zones 221. The pair of first cutting zones 221 are spaced apart and connected to the opposing side walls of the first guide channel 21. Each first cutting zone 221 includes multiple first cutting projections 2215, each extending upward from an upper surface of the respective first cutting zone 221.

The second cutting assembly 30 is located on the opposite lateral side of the main body 10, enabling the user to toggle between the cutting assemblies by simply flipping the main body 10, thereby enhancing operational efficiency.

The second cutting assembly 30 comprises a second guide channel 31 and a second cutting unit 32 positioned within the second guide channel 31. The second cutting unit 32 includes a second cutting zone 321 located between a pair of second support zones 322, with the second cutting zone 321 extending above the pair of second support zones 322. The pair of second support zones 322 are spaced apart and connected to the opposing side walls of the second guide channel 31. The second cutting zone 321 includes multiple second cutting projections 3215, each extending upward from an upper surface of the respective second cutting zone 321.

The first guide channel 21 aligns with the edge of one plate 70, allowing the first cutting unit 22 to process the plate 70 along the longitudinal axis A1, forming a convex edge 701. Similarly, the second guide channel 31 aligns with the edge of another plate 70, enabling the second cutting unit 32 to form a complementary concave edge 702.

By utilizing the first cutting assembly 20 and the second cutting assembly 30, the present invention facilitates the creation of interlocking convex and concave edges 701, 702 on the corresponding edges of two plates 70. This ensures precise alignment and stable assembly.

Since the primary purpose of the convex edge 701 and the concave edge 702 is to enable joint formation, their dimensions are carefully optimized to minimize excessive material removal. As a result, the convex edge 701 features a slight outward projection, while the concave edge 702 has a corresponding shallow recess. This design ensures a smooth and seamless interface between adjacent plates 70.

Structurally, the widths of both the first guide channel 21 and the second guide channel 31 correspond to the thickness of the plate. This alignment ensures cutting stability when both channels are aligned with the edge of the plate 70. Additionally, the width of the first support zone 222 matches that of the second cutting zone 321. This allows the convex edge 701, formed by the first cutting unit 22, to fit precisely into the concave edge 702, formed by the second cutting unit 32.

In certain embodiments, each first cutting zone 221 of the first cutting unit 22 is perforated with multiple first apertures 2211, while the second cutting zone 321 of the second cutting unit 32 includes multiple second apertures 3211. Each first cutting projection 2215 and second cutting projection 3215 are arranged around the periphery of these apertures.

For example, the first and second cutting assemblies 20, 30 may be made of metal, with the apertures 2211, 3211 produced via punching processes. The residual burrs formed during the punching process serve as sharp cutting edges, functioning directly as the first cutting projections 2215 and the second cutting projections 3215.

To optimize cutting performance, in some embodiments, the first apertures 2211 and the second apertures 3211 are arranged in a staggered configuration. This staggered configuration ensures that the first cutting projections 2215 on the first apertures 2211 and the second cutting projections 3215 on the second apertures 3211 promote uniform cutting, reduce resistance, and enhance the overall smoothness of the cutting process, thereby improving operational efficiency.

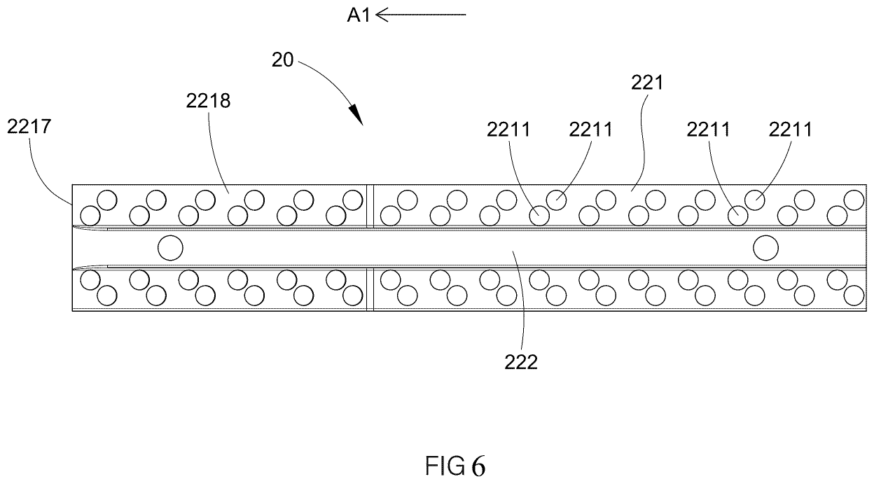

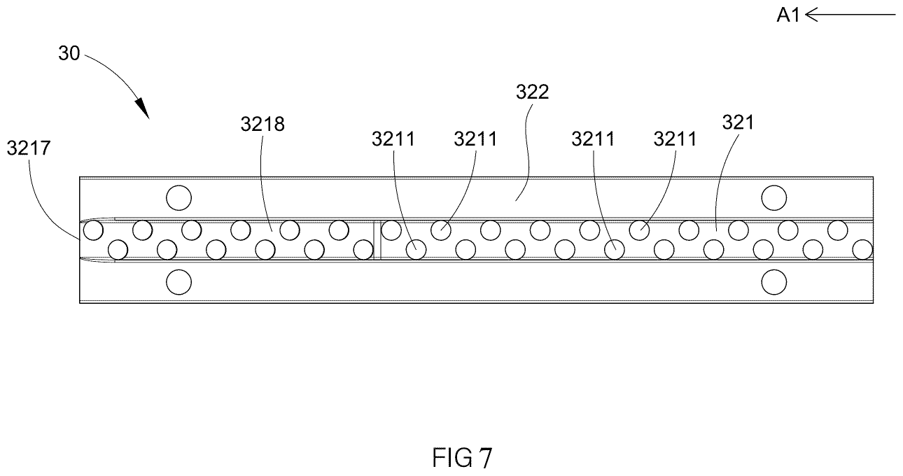

In additional embodiments, a spacing between the adjacent first apertures 2211 is less than or equal to their respective diameters, and this same principle applies to the second apertures 3211. As shown in FIGS. 6 and 7, the spacing between the apertures may be adjusted according to specific application requirements.

It should be noted that the arrangement and spacing of the apertures 2211 and 3211 create a front-to-back inclined configuration, which effectively reduces cutting resistance and enhances overall cutting efficacy.

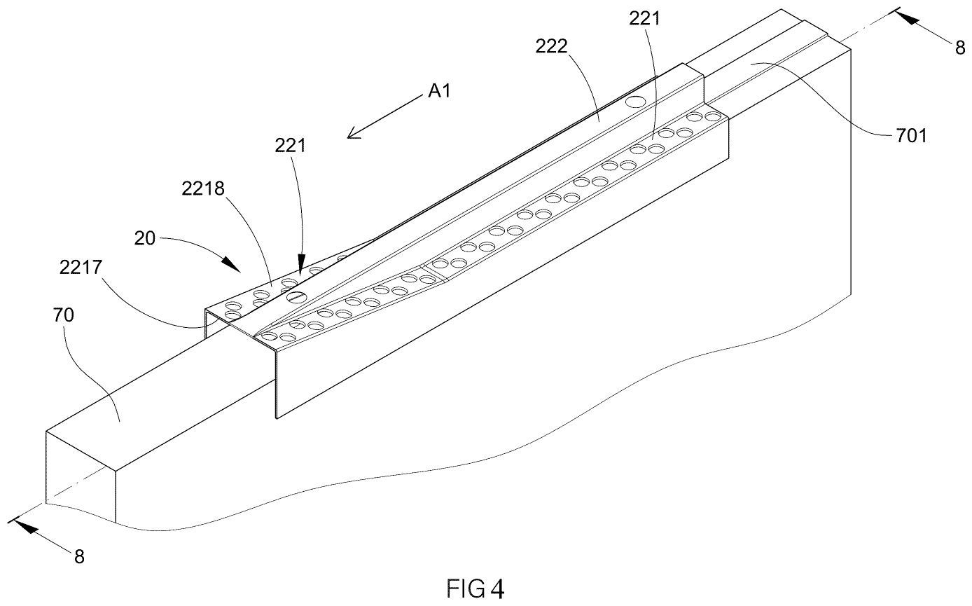

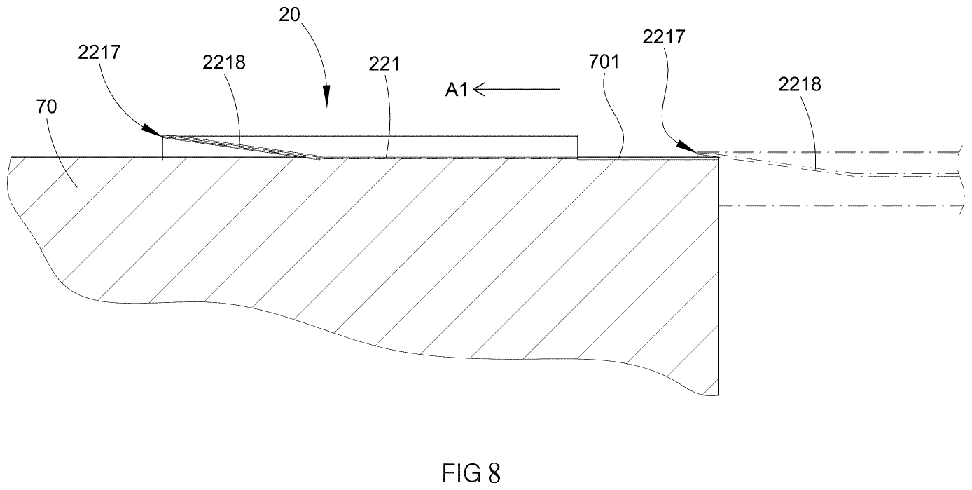

To facilitate ease of use, the first cutting zone 221 further includes a first entry point 2217 and a first guiding surface 2218. The height of the first guiding surface 2218 gradually decreases toward the first entry point 2217, forming an inclined surface. As shown in FIGS. 4 and 8, during operation, the first entry point 2217 aligns with the leading edge of the plate 70. The plate cutting device 100 advances toward the first entry point 2217 along the longitudinal axis A1, allowing the first guide channel 21 to engage the plate edge. The first cutting zone 221 then initiates the cutting process, guided by the first guiding surface 2218, to form the convex edge 701.

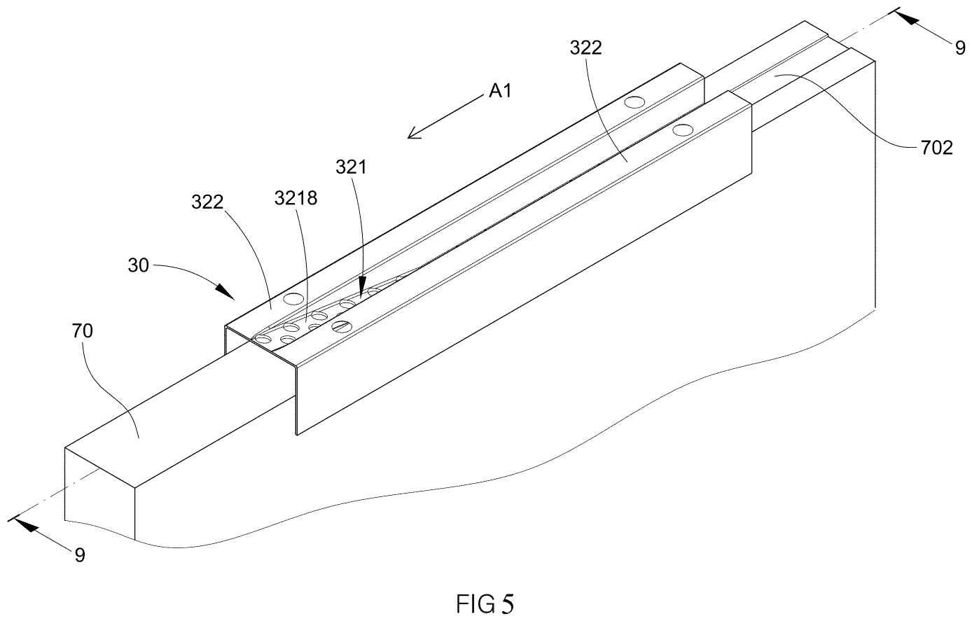

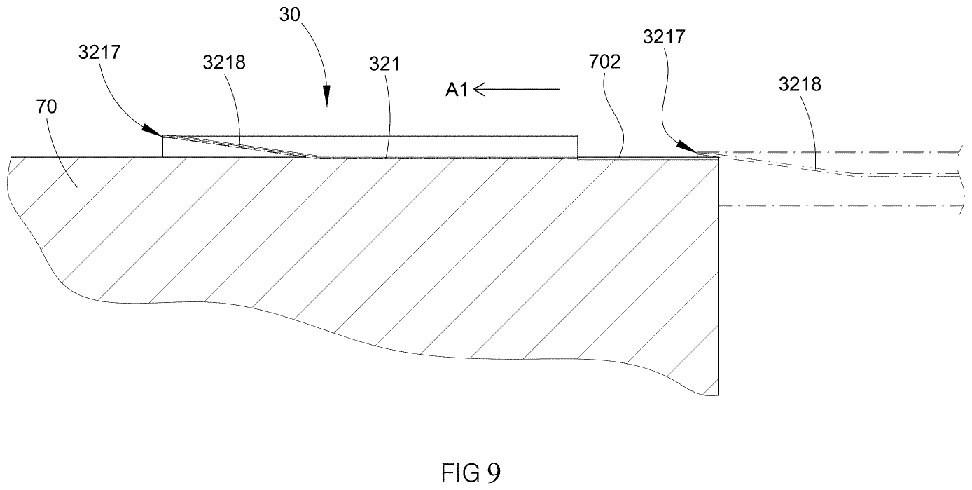

Similarly, the second cutting zone 321 further includes a second entry point 3217 and a second guiding surface 3218, which also features a gradually decreasing height forming an inclined surface. As shown in FIGS. 5 and 9, during operation, the second entry point 3217 aligns with the leading edge of the plate 70. The plate cutting device 100 advances toward the second entry point 3217 along the longitudinal axis A1, allowing the second guide channel 31 to engage the plate edge. The second cutting zone 321 then initiates the cutting process, guided by the second guiding surface 3218, to form the concave edge 702.

For clarity in illustrating the cutting operation, FIGS. 4 and 8 show only the first cutting assembly 20, while FIGS. 5 and 9 show only the second cutting assembly 30. The main body 10 is omitted from both sets of drawings.

In certain embodiments, the first and second cutting assemblies 20, 30 are detachably mounted to the main body 10. The main body 10 includes a first assembly slot 11 and a second assembly slot 12 on opposite sides, designed to accommodate the detachable installation of the first and second cutting assemblies 20, 30, respectively.

For example, the plate cutting device 100 may include multiple securing components 50. The first support zone 222 is equipped with first fastening holes 20A, while the second support zones 322 are provided with second fastening holes 30A. The securing components 50 pass through these holes, securing the first and second cutting assemblies 20, 30 within their respective assembly slots 11, 12.

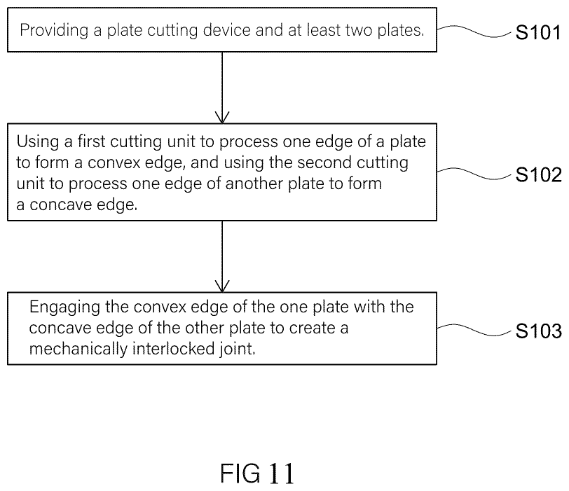

As shown in FIG. 11, the present invention also provides an implementation method, comprising the following steps:
Step (A) S101: Providing a plate cutting device 100 described above and at least two plates 70, such as rectangular gypsum boards.
Step (B) S102: Using the first cutting unit 22 to process an edge of a plate 70, forming a convex edge 701, and using the second cutting unit 32 to process an edge of another plate 70, forming a concave edge 702.
Step (C) S103: Engaging the convex edge 701 of one plate 70 with the concave edge 702 of the other plate 70, creating a mechanically interlocked joint.

From the above description, it is evident that the present invention utilizes the first cutting assembly and the second cutting assembly to process the joint surfaces of two plates into a convex edge and a concave edge, respectively. This enhances the stability of plate joining and effectively addresses the inconsistencies associated with conventional joint formation methods.

What is claimed is:

1. A plate cutting device configured to process the edges of multiple plates, the plate cutting device comprising:
a main body extending along a longitudinal axis;
a first cutting assembly positioned on one lateral side of the main body, the first cutting assembly comprising a first guide channel and a first cutting unit positioned within the first guide channel, the first cutting unit including a pair of first cutting zones and a first support zone, with the first support zone being recessed between the pair of first cutting zones, and each first cutting zone including multiple first cutting projections extending upward from an upper surface of the respective first cutting zone; and
a second cutting assembly positioned on the opposite lateral side of the main body, the second cutting assembly comprising a second guide channel and a second cutting unit positioned within the second guide channel, the second cutting unit including a second cutting zone located between a pair of second support zones, with the second cutting zone extending above the pair of second support zones, and the second cutting zone including multiple second cutting projections extending upward from an upper surface of the respective second cutting zone;
wherein the first guide channel is configured to align with an edge of a plate to guide the first cutting unit in processing the plate along the longitudinal axis to form a convex edge, and the second guide channel is configured to align with an edge of another plate to guide the second cutting unit in processing the plate along the longitudinal axis to form a concave edge, such that the two plates are joinable through interlocking engagement of the convex edge and the concave edge.

2. The plate cutting device according to claim 1, wherein each first cutting zone includes multiple first apertures, the second cutting zone includes multiple second apertures, each first cutting projection is arranged around the periphery of a corresponding first aperture, and each second cutting projection is arranged around the periphery of a corresponding second aperture.

3. The plate cutting device according to claim 2, wherein the first apertures are arranged in a staggered configuration, and the second apertures are arranged in a staggered configuration.

4. The plate cutting device according to claim 3, wherein a spacing between the adjacent first apertures is less than or equal to a diameter of the first apertures, and a spacing between the adjacent second apertures is less than or equal to a diameter of the second apertures.

5. The plate cutting device according to claim 2, wherein the first apertures and the second apertures are formed by a punching process, and the first cutting projections and the second cutting projections are burrs resulting from the punching process.

6. The plate cutting device according to claim 4, wherein the first apertures and the second apertures are formed by a punching process, and the first cutting projections and the second cutting projections are burrs resulting from the punching process.

7. The plate cutting device according to claim 1, wherein the main body further comprises a first assembly slot and a second assembly slot disposed on opposite lateral sides, and the first cutting assembly and the second cutting assembly are detachably mounted in the first assembly slot and the second assembly slot, respectively.

8. The plate cutting device according to claim 7, further comprising multiple securing components, wherein the first support zone includes multiple first fastening holes, each second support zone includes multiple second fastening holes, and each securing component extends through a first fastening hole and a second fastening hole to secure the first cutting assembly and the second cutting assembly within the first assembly slot and the second assembly slot, respectively.

9. The plate cutting device according to claim 1, wherein each first cutting zone includes a first entry point and a first guiding surface, the first guiding surface having a height that gradually decreases toward the first entry point, and each second cutting zone includes a second entry point and a second guiding surface, the second guiding surface having a height that gradually decreases toward the second entry point.

10. A method of implementing the plate cutting device, comprising the steps of:
Step (A): providing a plate cutting device as disclosed in claims 1 through 8, along with at least two plates;
Steps (B): using the first cutting unit to process an edge of a plate, forming a convex edge, and using the second cutting assembly to process an edge of another plate, forming a concave edge; and
Step (C): engaging the convex edge of one plate with the concave edge of the other plate, creating a mechanically interlocked joint.
